(19) United States
(12) Patent Application Publication
(10) Pub. No.: US 2026/0186502 A1
(43) Pub. Date: Jul. 2, 2026

(54) METHOD AND ELECTRONIC DEVICE WITH AFFORDANCE INFORMATION

(71) Applicant: Samsung Electronics Co., Ltd., Suwon-si (KR)

(72) Inventors: Young Rae CHO, Suwon-si (KR); Gunhee KOO, Suwon-si (KR); Joohan NA, Suwon-si (KR); ByeongJu LEE, Suwon-si (KR); Dohyun JANG, Suwon-si (KR); Hyunsoo CHA, Suwon-si (KR)

(73) Assignee: Samsung Electronics Co., Ltd., Suwon-si (KR)

(21) Appl. No.: 19/284,566

(22) Filed: Jul. 29, 2025

(30) Foreign Application Priority Data
Dec. 27, 2024 (KR) 10-2024-0199252

(51) Int. Cl. G05D 1/648; G05D 1/225; G05D 111/10

(52) U.S. Cl. CPC G05D 1/6484; G05D 1/225; G05D 2111/10

(57) ABSTRACT

A processor-implemented method includes, based on scene information about a space, generating a first object set for objects associated with a first unit space among one or more unit spaces of the space, generating a first object affordance information set for the first object set by obtaining object affordance information for each of the objects of the first object set, generating first space affordance information corresponding to the first unit space by inputting the first object affordance information set for the first object set to a first model, and in response to receiving a task of a robot associated with the space, generating a movement path for accomplishing the task of the robot based on the first space affordance information.

### CROSS-REFERENCE TO RELATED APPLICATIONS

This application claims the benefit under 35 USC § 119(a) of Korean Patent Application

No. 10-2024-0199252, filed on Dec. 27, 2024 in the Korean Intellectual Property Office, the entire disclosure of which is incorporated herein by reference for all purposes.

### BACKGROUND

### 1. Field

The following description relates to a method and electronic device with affordance information.

### 2. Description of Related Art

Vision language action (VLA) technology is a robot control technology that enables a robot to understand a person's natural language commands and images and perform tasks autonomously based on the commands and images. When a natural language command for a robot is received, i) a plan for accomplishing a task indicated by the natural language command may be established based on information about a space obtained in advance through a three-dimensional (3D) scan and the like, and ii) the robot's movements for executing each of the detailed actions included in the plan established based on the images may be determined.

When the information about the space obtained in advance is incomplete, the robot may not be able to establish a plan for accomplishing the task or may establish an inefficient plan. For example, when a task for the robot includes an action of searching for a target object and the information about the space obtained in advance fails to include information indicating the target object, the robot may output that the task may not be performed or may search for the target object according to a movement path generated by a preset rule.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes, based on scene information about a space, generating a first object set for objects associated with a first unit space among one or more unit spaces of the space, generating a first object affordance information set for the first object set by obtaining object affordance information for each of the objects of the first object set, generating first space affordance information corresponding to the first unit space by inputting the first object affordance information set for the first object set to a first model, and in response to receiving a task of a robot associated with the space, generating a movement path for accomplishing the task of the robot based on the first space affordance information.

The method may include generating first task affordance information by inputting, to a second model, an input prompt indicating the task of the robot associated with the space, and based on the first space affordance information and the first task affordance information, generating a first priority list indicating a priority order among the one or more unit spaces in accomplishing the task.

The generating of the first priority list may include determining a first similarity between the first task affordance information and the first space affordance information corresponding to the first unit space among the one or more unit spaces, determining a second similarity between the first task affordance information and second space affordance information corresponding to a second unit space among the one or more unit spaces, and based on the first similarity and the second similarity, determining a priority order between the first unit space and the second unit space.

The method may include, based on the first priority list and the input prompt, generating a sub-task set indicating movements of the robot for accomplishing the task.

The method may include, based on a first image of the robot and the sub-task set, generating a control signal of the robot for accomplishing the task, and transmitting the control signal to the robot.

The first model may be implemented based on all or part of either one or both of an artificial intelligence (AI)-based classifier and a large language model (LLM).

The second model may be implemented based on all or part of either one or both of an artificial intelligence (AI)-based classifier and a large language model (LLM).

The scene information about the space may include any one or any combination of any two or more of information indicating a structure of the space, information indicating the one or more unit spaces that are determined for the space, and information indicating objects that are detected in the space.

In one or more general aspects, a non-transitory computer-readable storage medium may store instructions that, when executed by one or more processors, configure the one or more processors to perform any one, any combination, or all of operations and/or methods described herein.

In one or more general aspects, an electronic device includes one or more processors comprising processing circuitry, and memory comprising one or more storage media storing instructions that, when executed individually or collectively by the one or more processors, cause the electronic device to, based on scene information about a space, generate a first object set for objects associated with a first unit space among one or more unit spaces of the space, generate a first object affordance information set for the first object set by obtaining object affordance information for each of the objects of the first object set, generate first space affordance information corresponding to the first unit space by inputting the first object affordance information set for the first object set to a first model, and in response to receiving a task of a robot associated with the space, generate a movement path for accomplishing the task of the robot based on the first space affordance information.

The execution of the instructions may cause the electronic device to generate first task affordance information by inputting, to a second model, an input prompt indicating the task of the robot associated with the space, and based on the first space affordance information and the first task affordance information, generate a first priority list indicating a priority order among the one or more unit spaces in accomplishing the task.

For the generating of the first priority list, the execution of the instructions may cause the electronic device to determine a first similarity between the first task affordance information and the first space affordance information corresponding to the first unit space among the one or more unit spaces, determine a second similarity between the first task affordance information and second space affordance information corresponding to a second unit space among the one or more unit spaces, and, based on the first similarity and the second similarity, determine a priority order between the first unit space and the second unit space.

The execution of the instructions may cause the electronic device to, based on the first priority list and the input prompt, generate a sub-task set indicating movements of the robot for accomplishing the task.

The execution of the instructions may cause the electronic device to, based on a first image of the robot and the sub-task set, generate a control signal of the robot for accomplishing the task, and transmit the control signal to the robot.

The first model may be implemented based on all or part of either one or both of an artificial intelligence (AI)-based classifier and a large language model (LLM).

The second model may be implemented based on all or part of either one or both of an artificial intelligence (AI)-based classifier and a large language model (LLM).

The scene information about the space may include any one or any combination of any two or more of information indicating a structure of the space, information indicating the one or more unit spaces that are determined for the space, and information indicating objects that are detected in the space.

In one or more general aspects, a processor-implemented method includes based on scene information about a space, generating space affordance information of each of one or more unit spaces of the space, generating first task affordance information by inputting, to a second model, an input prompt indicating a task of the robot associated with the space, based on the first task affordance information and space affordance information of each of the one or more unit spaces, generating a first priority list indicating a priority order among the one or more unit spaces in accomplishing the task, based on the first priority list and the input prompt, generating a sub-task set indicating movements of the robot for accomplishing the task, and based on the sub-task set, generating a control signal of the robot for accomplishing the task.

The obtaining of the space affordance information of each of the one or more unit spaces o the space, based on the scene information, may include based on the scene information, generating a first object set for objects associated with a first unit space among the one or more unit spaces, generating a first object affordance information set for the first object set by generating object affordance information for each of the objects of the first object set, and generating first space affordance information corresponding to the first unit space by inputting the first object affordance information set for the first object set to a first model.

The generating of the first priority list may include determining a first similarity between the first task affordance information and the first space affordance information corresponding to a first unit space among the one or more unit spaces, determining a second similarity between the first task affordance information and second space affordance information corresponding to a second unit space among the one or more unit spaces, and based on the first similarity and the second similarity, determining a priority order between the first unit space and the second unit space.

Other features and aspects will be apparent from the following detailed description, the drawings, and the claims.

### BRIEF DESCRIPTION OF THE DRAWINGS

FIG. 1 illustrates an example of operations in which an electronic device controls a robot according to one or more embodiments.

FIG. 2 illustrates an example of a configuration of an electronic device according to one or more embodiments.

FIG. 3 illustrates an example of a method of obtaining space affordance information according to one or more embodiments.

FIG. 4 illustrates an example of an operation of obtaining space affordance information of a unit space according to one or more embodiments.

FIG. 5 illustrates an example of a method of controlling a robot based on space affordance information according to one or more embodiments.

FIG. 6 illustrates an example of a method of generating a priority list for accomplishing a task according to one or more embodiments.

FIG. 7 illustrates an example of an operation of generating a priority order for accomplishing a task according to one or more embodiments.

FIG. 8 illustrates an example of a method of controlling a robot based on scene information and an input prompt according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the present disclosure. Terms, such as those defined in commonly used dictionaries, are to be interpreted as having a meaning that is consistent with their meaning in the context of the relevant art and specifically in the context of the present disclosure, and are not to be construed as an ideal or excessively formal meaning unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment“ and 'in an or one example embodiment'), and ”one or more examples“ has a same meaning as ”one or more embodiments“ and ”one or more example embodiments“. Still further, each of multiple or all separately described an/one ”example“, ”embodiment“, ”example embodiment“, as well as ”examples“, ”embodiments“, ”example embodiments“, herein may be included, in combination, in a same embodiment in any combination.

Hereinafter, examples are described in detail with reference to the accompanying drawings. When describing the examples with reference to the accompanying drawings, like reference numerals refer to like elements and a repeated description related thereto will be omitted.

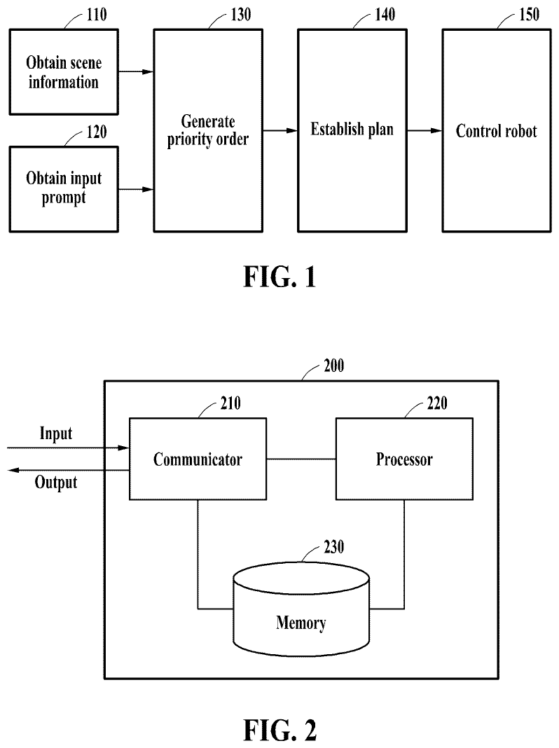

FIG. 1 illustrates an example of operations in which an electronic device controls a robot according to one or more embodiments.

An electronic device for controlling a robot may generate a control signal of the robot based on an input prompt and scene information. The electronic device may include a communication device, such as a smartphone and the like, a vehicle, such as an automobile and the like, a consumer electronic apparatus, such as a washing machine and the like, a manufacturing apparatus, and the like. For example, the robot may be a domestic robot, a humanoid, a robot arm, and/or an autonomous vehicle. The type of robot is not limited to the examples described above, and other types of robots that may accomplish (e.g., complete and/or successfully perform) a task by changing a state according to a control signal may exist. In other non-limiting examples, the electronic device may include the robot, the robot may include the electronic device, or the electronic device may be the robot. A task may be a task that the robot may perform based on a command (e.g., an input prompt) input to the robot. For example, in response to the input prompt “Bring me bag A”, a task of conveying bag A to the location of a user may be input to the robot.

The operations in which the electronic device controls the robot may include operation 110 of obtaining scene information, operation 120 of obtaining an input prompt, operation 130 of generating a priority order, operation 140 of establishing a plan, and operation 150 of controlling a robot. Operations 110 to 150 of FIG. 1 may be performed in the sequence and manner as illustrated in FIG. 1. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 110 of obtaining the scene information, the electronic device may collect and/or generate scene information about a space in which the robot performs a task. For example, the scene information may be a three-dimensional (3D) scene graph that represents a 3D environment with a plurality of nodes and a plurality of edges. In the 3D scene graph, each of the plurality of nodes may represent an object found in a space, a property of the object, and/or the hierarchical structure of the 3D environment. In the 3D scene graph, each of the plurality of edges may represent a relationship between the plurality of nodes (e.g., a spatial relationship indicating the location of an object, a functional relationship regarding interactions between objects, and/or an inclusion relationship between objects, etc.). For example, the scene information may include information (e.g., the number of rooms included in the space) indicating the structure of a space. For example, the scene information may include information (e.g., the type and location of an object) indicating one or more objects detected in the space.

The scene information may include information (e.g., the type and size of a room) indicating one or more unit spaces that may be determined for the space. A unit space may be a unit that divides the space to generate a path along which a robot moves to accomplish a task. For example, a unit space may be a room (e.g., a kitchen, a bedroom, a bathroom, etc.) included in a space. For example, a unit space may be a grid that divides a space into sections of a predetermined size. For example, a unit space may be furniture (e.g., a first shelf in a warehouse including a plurality of shelves) including at least one object in a space. The type of a unit space is not limited to the examples described above, and various criteria for dividing space into at least one region may be used to determine the unit space.

The electronic device may generate scene information about the space by processing data (e.g., a plurality of images) obtained through a sensor (e.g., a camera) attached to the robot. However, examples are not limited thereto, and data for generating scene information may be obtained by a sensor installed as a device separate from the robot. Scene information about a space in which a task is performed may be obtained in advance and stored in a memory before an input prompt is obtained.

In operation 120 of obtaining an input prompt, the electronic device may receive an input prompt indicating a task. For example, the input prompt may be a natural language instruction that is input by a user. For example, the electronic device may generate the input prompt by processing at least one of input audio data (e.g., a voice of a user) and/or input text data (e.g., text input data of a user) obtained from the robot or the electronic device.

In operation 130 of generating a priority order, the electronic device may generate a priority order among unit spaces included in the space corresponding to the task indicated by the input prompt. The electronic device of one or more embodiments may efficiently generate a movement path of the robot for accomplishing a task based on the priority order among the unit spaces.

Operation 130 of generating a priority order may be performed when the obtained scene information is determined to be incomplete to accomplish the task, and may not be performed when the obtained scene information is not determined to be incomplete (or is determined to be complete) to accomplish the task. For example, operation 130 of generating the priority order may be optionally performed only when the obtained scene information is determined to be incomplete to accomplish the task. For example, for a task of conveying bag A to a location of the user, when the scene information includes the coordinates of bag A, the electronic device may establish a plan for accomplishing the task without generating the priority order among the unit spaces. For example, for the task of conveying bag A to the location of the user, when the scene information does not include the coordinates of bag A, the electronic device may generate the priority order among the unit spaces and establish a plan for accomplishing the task based on the priority order.

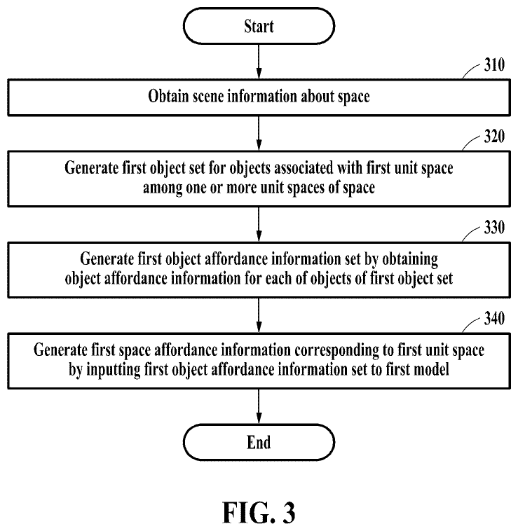

In operation 130, the electronic device may generate space affordance information for each of the unit spaces, generate task affordance information for a task, and determine, based on the space affordance information and the task affordance information, a priority order among the unit spaces corresponding to the task. Affordance information may be a parameter that indicates an interaction (an action, a function, and/or a purpose, etc.) implied by an object, a space, and/or a task. Examples of a method of determining a priority order among unit spaces corresponding to a task based on affordance information are described in detail below with reference to FIGS. 3 to 7.

In operation 140 of establishing a plan, the electronic device may generate a sub-task set to accomplish the task indicated by the input prompt. A sub-task may be one of the step-by-step tasks (e.g., movement and/or action of a robot) for accomplishing a task. For example, a sub-task set generated corresponding to a task of conveying bag A to the location of the user may include i) a sub-task of moving the robot to a target unit space where bag A is located, ii) a sub-task of searching for bag A in the target unit space, iii) a sub-task of moving the found end effector of the robot to the location of bag A, iv) a sub-task of lifting the end effector and bag A, v) a sub-task of moving the end effector and bag A to a default location, and vi) a sub-task of moving the robot to a unit space where the user is located. An end effector may be a tool (e.g., a gripper, a welding tool, a spray painting tool, a sensor, etc.) located at one end of a robot to perform a task.

In operation 150 of controlling a robot, the electronic device may generate a control signal of the robot for accomplishing the task based on the sub-task set. The electronic device may accomplish the task by controlling the robot such that each of the sub-tasks of the sub-task set is accomplished sequentially. The control signal may be a unit operation and/or an extremely small operation performed in a situation in which the control signal is generated among all operations of the robot (or the end effector of the robot) performed to perform a task.

The electronic device may use an obtained (e.g., captured) image of at least a portion of the robot and a situation in which the robot performs a task to generate the control signal. The electronic device may generate, based on at least a portion (e.g., an end effector) of the robot shown in the image and the situation in which the robot performs a task, the control signal of the robot for accomplishing a sub-task being performed by the robot. The electronic device may include an action generation model, which is a model generated and/or trained to output output data corresponding to a control signal of the robot from input data corresponding to an image and a sub-task. For example, the action generation model may be implemented based on all or part of at least one of a neural network (e.g., a convolutional neural network (CNN)), a transformer, a large language model (LLM), a vision language model (VLM), and/or a vision language action (VLA) model. For example, the image may be obtained by a camera mounted on the robot. However, examples are not limited thereto, and the image may be generated by a camera installed as a separate device from the robot.

FIG. 2 illustrates an example of a configuration of an electronic device.

An electronic device 200 (e.g., the electronic device including the action generation model may include a communicator 210 (e.g., one or more communicators), a processor 220 (e.g., one or more processors), and a memory 230 (e.g., one or more memories). The communicator 210 may be connected to the processor 220, the memory 230, and a robot to transmit and receive data to and from the processor 220, the memory 230, and the robot. The communicator 210 may be connected to another external device to transmit and receive data to and from the external device. Hereinafter, transmitting and receiving “A” may refer to transmitting and receiving “information or data indicating A”.

The communicator 210 may be implemented as circuitry in the electronic device 200. For example, the communicator 210 may include an internal bus and an external bus. In another example, the communicator 210 may be an element that connects the electronic device 200 to the external device. The communicator 210 may be or include an interface. The communicator 210 may receive data from the external device and transmit the data to the processor 220 and the memory 230.

The processor 220 may process the data received by the communicator 210 and data stored in the memory 230. A “processor” may be a hardware-implemented data processing device having a physically structured circuit to execute desired operations. For example, the desired operations may include code or instructions in a program. For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The processor 220 may execute computer-readable code (e.g., software) stored in a memory (e.g., the memory 230) and instructions triggered by the processor 220. For example, a method in which the electronic device 200 controls the robot may be performed by executing the instructions.

The memory 230 may store data received by the communicator 210 and data processed by the processor 220. For example, the memory 230 may store a program (or an application or software). The program to be stored may be a set of syntaxes that are coded and executable by the processor 220 to provide a method of controlling the robot.

The memory 230 may include, for example, at least one volatile memory, non-volatile memory, random-access memory (RAM), flash memory, a hard disk drive, and an optical disk drive.

The memory 230 may store an instruction set (e.g., software) for operating the electronic device 200. The instruction set for operating the electronic device 200 may be executed by the processor 220. For example, the memory 230 may be or include a non-transitory computer-readable storage medium storing instructions that, when executed by the processor 220, configure the processor 220 to perform any one, any combination, and/or all of operations and/or methods described herein with reference to FIGS. 1 to 8.

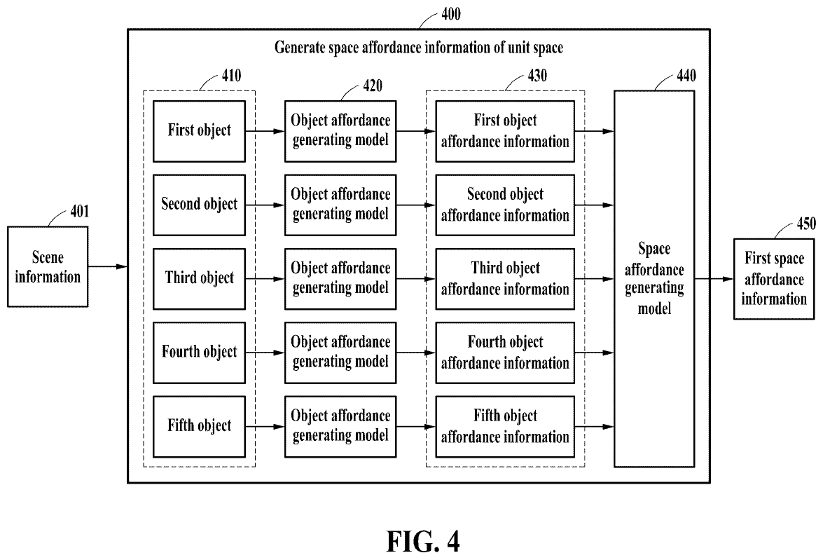

FIG. 3 illustrates an example of a method of generating space affordance information according to one or more embodiments. FIG. 4 illustrates an example of an operation of generating space affordance information of a unit space according to one or more embodiments.

Operations 310 to 340 of FIG. 3 may be performed by an electronic device (e.g., the electronic device 200 of FIG. 2). The electronic device may include a communicator (e.g., the communicator 210 of FIG. 2), at least one processor (e.g., the processor 220 of FIG. 2), and a memory (e.g., the memory 230 of FIG. 2). Operations 310 to 340 of FIG. 3 may be performed in the sequence and manner as illustrated in FIG. 3. However, one or more of the operations may be performed in a different order, one or more of the operations may be omitted, two or more of the operations may be performed in parallel or simultaneously, and/or other operations may be additionally performed without departing from the spirit and scope of the described embodiments.

The electronic device may generate space affordance information for each of the unit spaces and control a robot based on the space affordance for each of the unit spaces. Affordance information may be a parameter that indicates an interaction (an action, a function, and/or a purpose, etc.) implied by an object, a space, and/or a task. As the concept of affordance, which is abstractly defined only for objects, is represented as a feature vector in a high-dimensional manner and extended to a space and a task, affordance information may be used for task planning of a robot, and the movements of the robot to accomplish a task may be efficiently planned.

In operation 310, the electronic device may obtain scene information 401 about a space. For example, the scene information 401 may be a 3D scene graph generated for the space. For example, the scene information 401 may be generated as data obtained through a sensor attached to the robot is processed.

The scene information 401 about the space may include at least one of information indicating the structure of the space, information indicating one or more unit spaces that may be determined for the space, and/or information indicating one or more objects detected in the space. A unit space may be a unit that divides the space to generate a path along which a robot moves to accomplish a task. For example, the scene information 401 may include information about one or more unit spaces included in the space and may include information about objects detected in each of the unit spaces. When the scene information 401 includes properties and relationships of each hierarchical element (a space, a unit space, and/or objects) related to the space, complex information for task planning may be provided.

As illustrated in FIG. 4, in operation 400 of generating a space affordance of a unit space, based on the obtained scene information 401, the electronic device may generate first space affordance information 450 for a first unit space.

In operation 320, the electronic device may generate a first object set 410 for objects associated with the first unit space among one or more unit spaces of the space based on the scene information 401. The first object set 410 may include at least one object found in the first unit space. For example, when the first unit space is a bedroom, the first object set may include a bed, a nightstand, a pillow, a blanket, a side table, and/or a clock.

In operation 330, the electronic device may generate a first object affordance information set 430 by generating object affordance information for each object in the first object set 410. The object affordance information may be a parameter that indicates an interaction (an action, a function, a purpose, etc.) implied by a predetermined object. For example, when an object is a knife, a feature vector related to cooking, a cutting board, and/or cutting may be generated as the object affordance information. By generating information about an identified object as a feature vector representing the affordance of the object in a high-dimensional manner, as opposed to a case in which the information is represented as a plurality of words (or variables) corresponding to the properties of the object, the electronic device of one or more embodiments may efficiently process the complex properties of the object.

As illustrated in FIG. 4, the electronic device may generate object affordance information about an object by inputting generated information about the object to an object affordance generating model 420. The object affordance generating model 420 may be an artificial intelligence (AI) model that is generated and/or trained to output, as output data, object affordance information corresponding to various interaction possibilities of the object from input data indicating properties (type, shape, size, color, etc.) of the identified object. For example, the object affordance generating model 420 may be implemented based on all or part of at least one of an AI-based classifier and/or an LLM. For example, the object affordance generating model 420 may generate a plurality of object feature vectors corresponding to a plurality of object features (e.g., an object interaction) and generate object affordance information based on the plurality of object feature vectors. For example, the object affordance generating model 420 may be a model that is updated or trained in advance based on a training data set in which an interaction that appears for a predetermined object is labeled in detail. “Updating” may be the act of training a machine learning model using a training data set such that the model learns to represent an output corresponding to a new input.

The electronic device may include a database storing object affordance information for each of a plurality of identifiable objects and may determine any one piece of the stored object affordance information as object affordance information corresponding to an identified object. By using object affordance information from a pre-generated database, the electronic device of one or more embodiments may save computational resources and time required to generate space affordance information.

In operation 340, the electronic device may generate first space affordance information 450 corresponding to the first unit space by inputting the first object affordance information set 430 to the first model. Space affordance information may be a parameter that indicates an interaction (an action, a function, a purpose, etc.) implied by a predetermined unit space. For example, when the first unit space is a kitchen, a feature vector related to cooking, washing, ingredients, storage, and/or food may be generated as the first space affordance information 450.

By generating information about a unit space as a feature vector representing the affordance of the unit space in a high-dimensional manner, as opposed to a case in which the information about the unit space is represented as a plurality of words (or variables) corresponding to the properties of the unit space, the electronic device of one or more embodiments may efficiently process the complex properties of the unit space. For example, when the property of the first unit space is simply represented as “bedroom”, complex properties (e.g., sleeping, reading, watching movies, etc.) regarding the purpose for which a predetermined user utilizes the bedroom may not be reflected. However, by generating the property of the first unit space as space affordance information generated based on objects placed in the bedroom, the electronic device of one or more embodiments may reflect complex properties regarding the purpose for which the predetermined user utilizes the bedroom.

As illustrated in FIG. 4, the first model may be a space affordance generating model 440. The electronic device may generate space affordance information about a unit space by inputting the object affordance information set 430 to the space affordance generating model 440. The space affordance generating model 440 may be an AI model generated and/or trained to output, as output data, space affordance information corresponding to various interaction possibilities in a unit space from input data indicating object affordance information of each object included in the space. For example, the space affordance generating model 440 may be implemented based on all or part of at least one of an AI-based classifier and/or an LLM. For example, the space affordance generating model 440 may be a model that is updated or trained in advance based on a training data set using unsupervised learning (e.g., clustering).

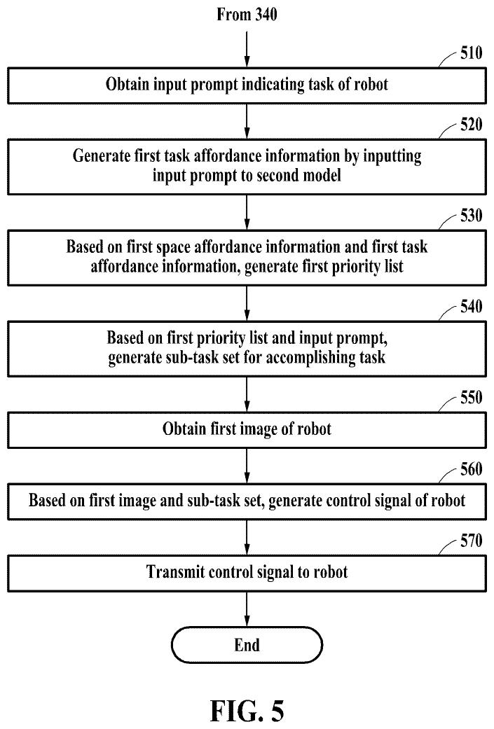

As a result of operations 320 and 330 being repeated for each of the plurality of unit spaces included in the space, space affordance information for each of the plurality of unit spaces may be generated. The electronic device may control the robot based on space affordance information for the plurality of unit spaces. Examples of a method of controlling a robot based on space affordance information about a plurality of unit spaces are described in detail below with reference to FIGS. 5 to 7.

FIG. 5 illustrates an example of a method of controlling a robot based on space affordance information according to one or more embodiments.

Operations 510 to 570 of FIG. 5 may be performed by an electronic device (e.g., the electronic device 200 of FIG. 2). The electronic device may include a communicator (e.g., the communicator 210 of FIG. 2), at least one processor (e.g., the processor 220 of FIG. 2), and a memory (e.g., the memory 230 of FIG. 2). For example, operations 510 to 570 may be performed after operation 340 described above with reference to FIG. 3 is performed. Operations 510 to 570 of FIG. 5 may be performed in the sequence and manner as illustrated in FIG. 5. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 510, the electronic device may obtain an input prompt indicating a task of a robot associated with a space. For example, the input prompt may be a natural language instruction that is input by a user. For example, the input prompt may be generated by processing at least one of input audio data (e.g., a voice of a user) or input text data (e.g., text input data of a user) obtained from the robot or the electronic device.

In operation 520, the electronic device may generate first task affordance information by inputting an input prompt to a second model. Task affordance information may be a parameter that indicates an interaction (an action, a function, a purpose, etc.) implied by a task indicated by the input prompt. For example, when a task is to convey “bag A” to the location of the user, feature vectors related to the bag, miscellaneous goods, and a wardrobe may be generated as first task affordance information. By generating information about a task represented as a feature vector, the electronic device of one or more embodiments may efficiently process the complex properties of the task together with space affordance information.

The second model may be a task affordance generating model. The electronic device may generate task affordance information about a task by inputting an input prompt to the task affordance generating model. The task affordance generating model may be an AI model that is generated and/or trained to output, as output data, task affordance information corresponding to various interaction possibilities of a task indicated by the input prompt from input data indicating the input prompt. For example, the task affordance model may be implemented based on all or part of at least one of an AI-based classifier and/or an LLM. By implementing the task affordance model based on a giant LLM, the electronic device of one or more embodiments may efficiently process a relationship between texts included in a natural language command.

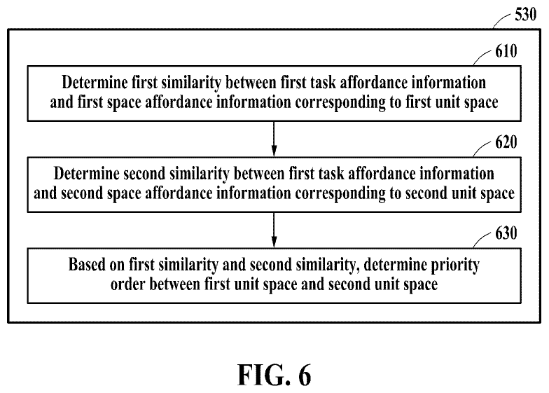

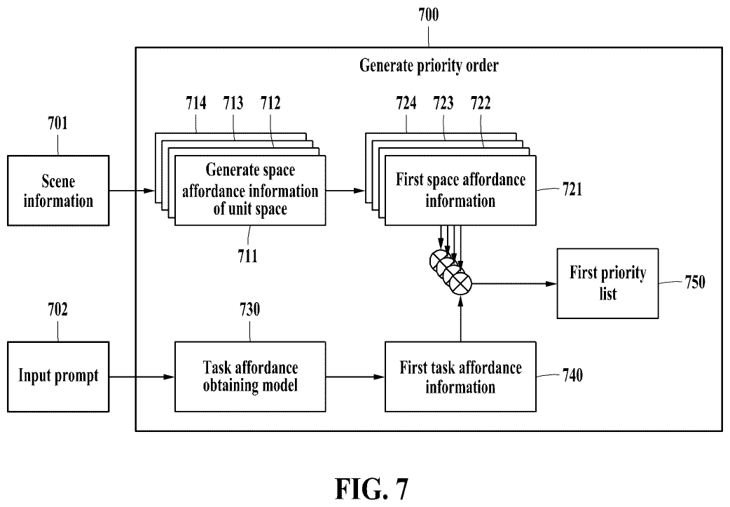

In operation 530, based on first space affordance information and the first task affordance information, the electronic device may generate a first priority list indicating a priority order among one or more unit spaces in accomplishing a task. Based on space affordance information about a plurality of unit spaces and task affordance information, the electronic device may generate the first priority list. Examples of the operation of generating the first priority list are described below in detail with reference to FIGS. 6 and 7.

In operation 540, based on the first priority list and the input prompt, the electronic device may generate a sub-task set indicating movements of a robot for accomplishing a task. A sub-task may be each of the step-by-step tasks (e.g., movement or action of a robot) for accomplishing a task. For example, operation 540 may be performed in operation 140 of establishing a plan described above with reference to FIG. 1.

In operation 550, the electronic device may obtain a first image of the robot. For example, the first image may be an image obtained (e.g., captured) with respect to a situation in which at least a part of the robot and the robot perform a task. The first image may indicate an environment or a state corresponding to a timepoint that is either before the task, during the task, and/or after the task. The first image may include pixel values (e.g., an R value, a G value, and a B value) for each of a plurality of pixels.

In operation 560, based on the first image and the sub-task set, the electronic device may generate a control signal of the robot for accomplishing the task. For example, the electronic device may determine a first sub-task being performed among the sub-task set in a situation in which the first image is obtained and may generate a control signal for accomplishing the first sub-task. For example, the electronic device may include an action generation model, which is a model generated and/or trained to output output data corresponding to a control signal of the robot from input data corresponding to the first image and the first sub-task.

The electronic device may determine whether the first sub-task is accomplished when the robot is performing the first sub-task of the sub-task set. When the first sub-task is accomplished, the electronic device may update a sub-task state of the robot such that the robot performs a second sub-task performed after the first sub-task. The sub-task state of the robot may be a parameter indicating information about the sub-task that the robot performs.

In operation 570, the electronic device may transmit a control signal to the robot. The robot may operate at least a portion of the robot based on the control signal. In another non-limiting example where the electronic device is or includes the robot, in operation 570, the electronic device may control and/or operate at least a portion of the robot based on the control signal. Operations 550 and 560 may be performed in operation 150 of controlling the robot described above with reference to FIG. 1.

The electronic device may obtain a second image after the robot performs a movement corresponding to the control signal. The second image may be an image obtained with respect to a situation in which at least a part of the robot and the robot perform the task after the robot completes the movement corresponding to the control signal. The electronic device may generate a control signal to accomplish the task in a situation in which the second image is obtained by performing a method of controlling a robot in operations 550 to 570 based on the second image and the sub-task set. A task that appears in the input prompt may be accomplished as sub-tasks included in the sub-task set are sequentially accomplished by the generated control signal.

When the electronic device for controlling the robot fails to have scene information that is sufficient to accomplish a task (e.g., when the coordinates of a target object is not obtained in advance), the electronic device may determine that the robot may not perform the task or may establish a plan (e.g., a sub-task set) for performing the task based on a predetermined criterion. For example, the predetermined criterion may be a preset navigation path or a property analyzed for each of a plurality of unit spaces. By generating complex properties of a space and a task (e.g., affordance) as feature vectors of high-dimensional representation, in accomplishing a plan for performing a task, the electronic device of one or more embodiments may accurately generate a priority order among unit spaces, and may generate an efficient plan for accomplishing the task based on the priority order.

FIG. 6 illustrates an example of a method of generating a priority list for accomplishing a task according to one or more embodiments. FIG. 7 illustrates an example of an operation of generating a priority order for accomplishing a task according to one or more embodiments.

Operations 610 to 630 of FIG. 6 may be performed by an electronic device (e.g., the electronic device 200 of FIG. 2). The electronic device may include a communicator (e.g., the communicator 210 of FIG. 2), a processor (e.g., the processor 220 of FIG. 2), and a memory (e.g., the memory 230 of FIG. 2). For example, operation 530 described above with reference to FIG. 5 may include operations 610 to 630. Operations 610 to 630 of FIG. 6 may be performed in the sequence and manner as illustrated in FIG. 6. However, one or more of the operations may be performed in a different order, one or more of the operations may be omitted, two or more of the operations may be performed in parallel or simultaneously, and/or other operations may be additionally performed without departing from the spirit and scope of the described embodiments.

As illustrated in FIG. 7, the electronic device may generate a priority order (e.g., a first priority list 750) among a plurality of unit spaces based on pieces of space affordance information 721 to 724 and task affordance information 740 for the plurality of unit spaces. The pieces of space affordance information 721 to 724 for the plurality of unit spaces may be generated by performing operations 711 to 714 of generating space affordance information about a unit space for each of the plurality of unit spaces based on scene information 701 (e.g., operation 400 of generating space affordance information about a unit space of FIG. 4). The first task affordance information 740 may be generated as an input prompt 702 is processed by a task affordance generating model 730 (e.g., the second model of FIG. 5).

The electronic device may generate a priority list (e.g., the first priority list 750) based on a similarity between the task affordance information 740 and each of the pieces of space affordance information 721 to 724 for the plurality of unit spaces.

In operation 610, the electronic device may determine a first similarity between first space affordance information 721 corresponding to a first unit space among one or more unit spaces and the first task affordance information 740. For example, the electronic device may determine the first similarity by determining the cosine similarity between the first space affordance information 721 and the first task affordance information 740. The method of determining the first similarity is not limited to the described examples, and various methods of determining similarities between vectors may be used to determine the first similarity.

In operation 620, the electronic device may determine a second similarity between the first task affordance information 740 and second space affordance information 722 corresponding to a second unit space among the one or more unit spaces. The same method used to determine the first similarity between the first space affordance information 721 and the first task affordance information 740 in operation 610 may be used to determine the second similarity. In a non-limiting example, operation 620 may further include determining a third similarity between the first task affordance information 740 and third space affordance information 723 corresponding to a third unit space, and determining a fourth similarity between the first task affordance information 740 and fourth space affordance information 724 corresponding to a fourth unit space.

In operation 630, the electronic device may determine a priority order between the first unit space and the second unit space based on the first similarity and the second similarity. For example, when the first similarity is higher than the second similarity, the priority of the first unit space may be determined to be higher than the priority of the second unit space. For example, when the second similarity is higher than the first similarity, the priority of the second unit space may be determined to be higher than the priority of the first unit space. The first priority list 750 may be generated based on the priority order among the plurality of unit spaces. In a non-limiting example, operation 630 may include determining a priority order between the first unit space, the second unit space, the third unit space, and the fourth unit space based on the first similarity, the second similarity, the third similarity, and the fourth similarity. For example, the priority order of the unit spaces may be determined in order from a unit space corresponding to a highest similarity to a unit space corresponding to a lowest similarity.

The first priority list 750 may include scores determined for each of the plurality of unit spaces. For example, a first score determined for first unit spaces may be determined based on the first similarity between the first space affordance information and the first task affordance information. Since the priority order among the plurality of unit spaces is represented by scores, in an operation of generating a sub-task set for accomplishing a task, the priority order among the plurality of unit spaces may be significantly or slightly reflected based on the scores.

The electronic device may generate a sub-task set for accomplishing a task based on the first priority list 750. For example, in response to a task of conveying bag A to the location of a user, a priority list may be generated in which the priority of a dressing room is higher than the priority of a kitchen, and the electronic device may generate a sub-task set to search for the dressing room before the kitchen. For example, the electronic device may generate a sub-task set indicating a movement path that maximizes the likelihood of detecting an object relative to the distance or time moved based on the first priority list 750.

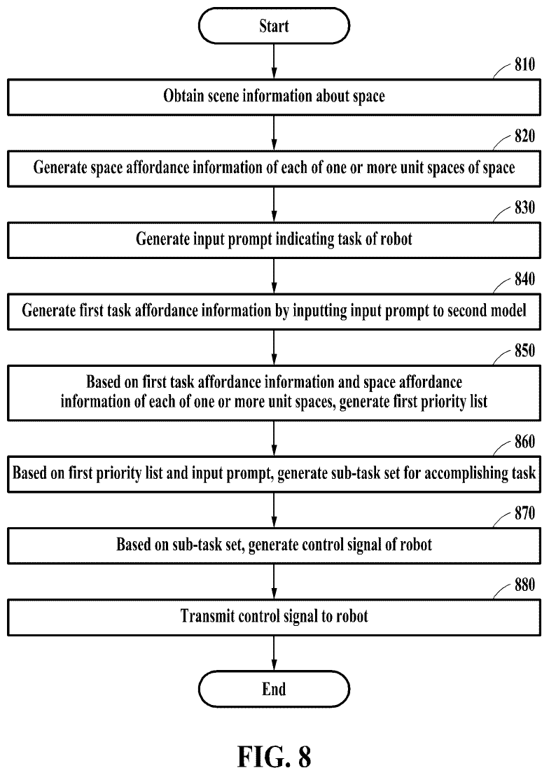

FIG. 8 illustrates an example of a method of controlling a robot based on scene information and an input prompt according to one or more embodiments.

Operations 810 to 880 of FIG. 8 may be performed by an electronic device (e.g., the electronic device 200 of FIG. 2). The electronic device may include a communicator (e.g., the communicator 210 of FIG. 2), a processor (e.g., the processor 220 of FIG. 2), and a memory (e.g., the memory 230 of FIG. 2). Operations 810 to 880 of FIG. 8 may be performed in the sequence and manner as illustrated in FIG. 8. However, one or more of the operations may be performed in a different order, one or more of the operations may be omitted, two or more of the operations may be performed in parallel or simultaneously, and/or other operations may be additionally performed without departing from the spirit and scope of the described embodiments.

The electronic device may generate space affordance information for each of the unit spaces and control a robot based on the space affordance for each of the unit spaces. By implementing the concept of affordance, which is abstractly defined only for objects, as a feature vector in a high-dimensional manner and extended to a space and a task, the electronic device of one or more embodiments may use affordance information for task planning of a robot, and may efficiently plan the movements of a robot to accomplish a task.

In operation 810, the electronic device may generate scene information about a space. The description of operation 310 described above with reference to FIG. 3 may similarly apply to the description of operation 810.

In operation 820, the electronic device may generate space affordance information of each of one or more unit spaces of the space based on the scene information. The description of operations 320 to 340 described above with reference to FIG. 3 may similarly apply to an operation of generating a first space affordance for a first unit space among one or more unit spaces in operation 820. In operation 830, the electronic device may generate an input prompt indicating a task of the robot associated with the space. The description of operation 510 described above with reference to FIG. 5 may similarly apply to the description of operation 830.

In operation 840, the electronic device may generate first task affordance information by inputting the input prompt to a second model. The description of operation 520 described above with reference to FIG. 5 may similarly apply to the description of operation 840.

In operation 850, based on first task affordance information and space affordance information of each of the one or more unit spaces, the electronic device may generate a first priority list indicating a priority order among the one or more unit spaces in accomplishing a task. The description of operation 530 described above with reference to FIG. 5 may similarly apply to the description of operation 850. For example, operation 850 may include operations 610 to 630 described above with reference to FIG. 6.

In operation 860, based on the first priority list and the input prompt, the electronic device may generate a sub-task set indicating movements of a robot for accomplishing a task. The description of operation 540 described above with reference to FIG. 5 may similarly apply to the description of operation 860.

In operation 870, the electronic device may generate a control signal of the robot based on the sub-task set. The description of operations 550 and 560 described above with reference to FIG. 5 may similarly apply to the description of operation 870.

In operation 880, the electronic device may transmit a control signal to the robot. The description of operation 570 described above with reference to FIG. 5 may similarly apply to the description of operation 880.

The electronic devices, communicators, processors, memories, electronic device 200, communicator 210, processor 220, and memory 230 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
based on scene information about a space, generating a first object set for objects associated with a first unit space among one or more unit spaces of the space;
generating a first object affordance information set for the first object set by obtaining object affordance information for each of the objects of the first object set;
generating first space affordance information corresponding to the first unit space by inputting the first object affordance information set for the first object set to a first model; and
in response to receiving a task of a robot associated with the space, generating a movement path for accomplishing the task of the robot based on the first space affordance information.

2. The method of claim 1, further comprising:
generating first task affordance information by inputting, to a second model, an input prompt indicating the task of the robot associated with the space; and
based on the first space affordance information and the first task affordance information, generating a first priority list indicating a priority order among the one or more unit spaces in accomplishing the task.

3. The method of claim 2, wherein the generating of the first priority list comprises:
determining a first similarity between the first task affordance information and the first space affordance information corresponding to the first unit space among the one or more unit spaces;
determining a second similarity between the first task affordance information and second space affordance information corresponding to a second unit space among the one or more unit spaces; and
based on the first similarity and the second similarity, determining a priority order between the first unit space and the second unit space.

4. The method of claim 2, further comprising, based on the first priority list and the input prompt, generating a sub-task set indicating movements of the robot for accomplishing the task.

5. The method of claim 4, further comprising:
based on a first image of the robot and the sub-task set, generating a control signal of the robot for accomplishing the task; and
transmitting the control signal to the robot.

6. The method of claim 1, wherein the first model is implemented based on all or part either one or both of an artificial intelligence (AI)-based classifier and a large language model (LLM).

7. The method of claim 2, wherein the second model is implemented based on all or part of either one or both of an artificial intelligence (AI)-based classifier and a large language model (LLM).

8. The method of claim 1, wherein the scene information about the space comprises any one or any combination of any two or more of information indicating a structure of the space, information indicating the one or more unit spaces that are determined for the space, and information indicating objects that are detected in the space.

9. A non-transitory computer-readable storage medium storing instructions that, when executed by one or more processors, configure the one or more processors to perform the method of claim 1.

10. An electronic device comprising:
one or more processors comprising processing circuitry; and
memory comprising one or more storage media storing instructions that, when executed individually or collectively by the one or more processors, cause the electronic device to:
based on scene information about a space, generate a first object set for objects associated with a first unit space among one or more unit spaces of the space;
generate a first object affordance information set for the first object set by obtaining object affordance information for each of the objects of the first object set;
generate first space affordance information corresponding to the first unit space by inputting the first object affordance information set for the first object set to a first model; and
in response to receiving a task of a robot associated with the space, generate a movement path for accomplishing the task of the robot based on the first space affordance information.

11. The electronic device of claim 10, wherein the execution of the instructions causes the electronic device to:
generate first task affordance information by inputting, to a second model, an input prompt indicating the task of the robot associated with the space; and
based on the first space affordance information and the first task affordance information, generate a first priority list indicating a priority order among the one or more unit spaces in accomplishing the task.

12. The electronic device of claim 11, wherein, for the generating of the first priority list, the execution of the instructions causes the electronic device to:
determine a first similarity between the first task affordance information and the first space affordance information corresponding to the first unit space among the one or more unit spaces;
determine a second similarity between the first task affordance information and second space affordance information corresponding to a second unit space among the one or more unit spaces; and
based on the first similarity and the second similarity, determine a priority order between the first unit space and the second unit space.

13. The electronic device of claim 11, wherein the execution of the instructions causes the electronic device to, based on the first priority list and the input prompt, generate a sub-task set indicating movements of the robot for accomplishing the task.

14. The electronic device of claim 13, wherein the execution of the instructions causes the electronic device to:
based on a first image of the robot and the sub-task set, generate a control signal of the robot for accomplishing the task; and
transmit the control signal to the robot.

15. The electronic device of claim 10, wherein the first model is implemented based on all or part of either one or both of an artificial intelligence (AI)-based classifier and a large language model (LLM).

16. The electronic device of claim 11, wherein the second model is implemented based on all or part of either one or both of an artificial intelligence (AI)-based classifier and a large language model (LLM).

17. The electronic device of claim 10, wherein the scene information about the space comprises any one or any combination of any two or more of information indicating a structure of the space, information indicating the one or more unit spaces that are determined for the space, and information indicating objects that are detected in the space.

18. A processor-implemented method comprising:
based on scene information about a space, generating space affordance information of each of one or more unit spaces of the space;
generating first task affordance information by inputting, to a second model, an input prompt indicating a task of the robot associated with the space;
based on the first task affordance information and space affordance information of each of the one or more unit spaces, generating a first priority list indicating a priority order among the one or more unit spaces in accomplishing the task;
based on the first priority list and the input prompt, generating a sub-task set indicating movements of the robot for accomplishing the task; and
based on the sub-task set, generating a control signal of the robot for accomplishing the task.

19. The method of claim 18, wherein the obtaining of the space affordance information of each of the one or more unit spaces of the space, based on the scene information, comprises:
based on the scene information, generating a first object set for objects associated with a first unit space among the one or more unit spaces;
generating a first object affordance information set for the first object set by generating object affordance information for each of the objects of the first object set; and
generating first space affordance information corresponding to the first unit space by inputting the first object affordance information set for the first object set to a first model.

20. The method of claim 18, wherein the generating of the first priority list comprises:
determining a first similarity between the first task affordance information and the first space affordance information corresponding to a first unit space among the one or more unit spaces;
determining a second similarity between the first task affordance information and second space affordance information corresponding to a second unit space among the one or more unit spaces; and
based on the first similarity and the second similarity, determining a priority order between the first unit space and the second unit space.
